(19) United States
(12) Patent Application Publication
(10) Pub. No.: US 2021/0174692 A1
(43) Pub. Date: Jun. 10, 2021

(54) Ritual Sense Design Methods of Educational Game Software For Improving Learning Motivation

(71) Applicant: Yuefei Su, Palo Alto, CA (US)

(72) Inventor: Yuefei Su, Palo Alto, CA (US)

(21) Appl. No.: 16/708,053

(22) Filed: Dec. 9, 2019

(51) Int. Cl. G09B 5/12; A63F 13/80; G09B 7/02

(52) U.S. Cl. CPC G09B 5/12; G09B 7/02; A63F 13/80

(57) ABSTRACT

Aspects of the present disclosure are presented for the ritual sense design principles of educational game software, including: the ritual sense design of educational game software needs to match the educational content, match the user's background, match the ceremonial occasion, match the achievements and prize levels, match the award category, and make full use of text, pictures, videos, sound effects, dubbing, Hyun color, colorful ribbon, special effects, adding points, etc.

The embodiment of this invention defines fifteen scenarios of the educational game software, in which ritual design should be applied, including: Adding Points for Correct Answer scenario, Getting Medals for Correct Answer scenario, Receiving Prizes scenario, Promotion scenario, Honor Presentation scenario, Role Model Presentation scenario, Study Certificate Presentation scenario, Graduation Certificate Presentation scenario, Leader-Board Presentation scenario, Transcript Presentation scenario, Study Badge Presentation scenario, Adding Buddy scenario, Receiving Gift scenario, Raffle scenario, and Adding Points for Sharing App scenario.

Based on the above design principles, the ritual sense design methods of educational game software are proposed, including: the ritual sense design methods of the main interface; the ritual sense design methods of course module; and the ritual sense design methods of achievement celebration scene.

### FIELD OF THE INVENTION

A method applied to the design of educational game software. The method can be used to improve the user's motivation for learning.

### BACKGROUND OF THE INVENTION

Ritual is a series of activities that have been given a certain value and significance, with repeated forms and regularities. It is a cultural phenomenon that has existed in human society since ancient times. Ritual and sense of ritual involve social psychology and personal psychology. Through ritual and ritual sense, people can get a certain kind of psychological feeling and stimulate people's emotions, so as to strengthen people's psychological connection with certain objects. Although the design of ritual and sense of ceremony requires time and energy, and may seem dispensable, it actually has a non-negligible impact on everyone's work and life.

Ceremonies in education include entrance ceremony, opening ceremony, oath ceremony, adult ceremony, graduation ceremony, school celebration ceremony, award ceremony, etc. The ritual sense created by these rituals of education can stimulate the sense of dignity, tolerance, mission, and pride associated with educational content in the minds of participants, thereby effectively enhancing learners' enthusiasm, concentration and courage to overcome difficulties. As an important resource of modern education, it is very necessary for educational game software to incorporate ritual sense design to create a useful sense of ritual, to help increase the enthusiasm of users to use educational game software, and to improve user learning results.

The ritual sense design of educational game software usually stimulates the user's vision, hearing, and touch through sounds, texts, pictures, and animation, which can touch the user's psychology, stimulate the production of Dopamine in the brain, form a pleasant psychology, and even flow, thus motivating users to achieve the next achievement, forming a habit of “addiction” to educational game software, improving learning motivation.

In order to attract and maintain the user's interest in the use of educational game software, the existing educational game software have more or less incorporated some ritual sense related designs in the design process. For example, in the use of educational game software, when a user passes a certain level, the software will play celebration music or words of encouragement and give tips on getting rewards; set a leader-board function to allow users to show their learning achievements. However, the existing educational game software still has room for improvement in terms of ritual sense design.

This invention aims at the lack of ritual sense design of the existing educational game software, and aims at improving the user's learning motivation. Based on the study and reference of the ritual sense training methods of actual educational activities, this invention proposes a kind of ritual sense design methods of educational game software.

### BRIEF SUMMARY OF THE INVENTION

This invention include ritual sense design methods of educational game software, which can make educational game software more interesting, and motivate users to focus on, and keep on learning.

The first major part of this invention includes the ritual sense design principles of educational game software, including: the ritual sense design of educational game software needs to match the educational content, match the user's background, match the ceremonial occasion, match the achievements and prize levels, match the award category, and make full use of text, pictures, videos, sound effects, dubbing, Hyun color, colorful ribbon, special effects, adding points,

The second major part of this invention includes description of scenarios of the educational game software, in which ritual design should be applied. The embodiment of this invention included fifteen software scenarios, comprising: Adding Points for Correct Answer scenario, Getting Medals for Correct Answer scenario, Receiving Prizes scenario, Promotion scenario, Honor Presentation scenario, Role Model Presentation scenario, Study Certificate Presentation scenario, Graduation Certificate Presentation scenario, Leader-Board Presentation scenario, Transcript Presentation scenario, Study Badge Presentation scenario, Adding Buddy scenario, Receiving Gift scenario, Raffling scenario, and Adding Points for Sharing App scenario.

The third major part of this invention includes ritual sense design methods of educational game software, including: the ritual sense design methods of the main interface; the ritual sense design methods of course module; and the ritual sense design methods of achievement celebration scene, wherein the ritual sense design methods of achievement celebration scene methods can be divided into eight modes, including: Opening Treasure Chest mode; Making A Glorious Return to One's Hometown mode; Succeeding in Imperial Examination mode; Graduation Ceremony mode; Universal Celebrations mode; Family Celebration mode; Personal Celebration mode; Teacher Rewarding Sticker mode, Happy Surprise mode. Each mode can be applied in a suitable application scenario.

The above simplified summary of this invention serves to provide a basic understanding of the present disclosure. This summary is not an extensive overview of all contemplated aspects, and is intended to neither identify key or critical elements of all aspects nor delineate the scope of any or all aspects of the present disclosure.

### BRIEF DESCRIPTION OF THE DRAWINGS

FIG. 1 shows legend of selection of ritual sense design elements

FIG. 2 shows legend of ritual sense design in the course module

FIG. 3 shows legend of Making a Glorious Return to One's Hometown mode

FIG. 4 shows legend of Succeeding in Imperial Examination mode

FIG. 5 shows legend of Graduation Ceremony mode

FIG. 6 shows legend of Universal Celebrations mode

FIG. 7 shows legend of Family Celebration mode

FIG. 8 shows legend of Personal Celebration mode

### DETAILED DESCRIPTION OF THE INVENTION

The sense of ritual in educational game software is related to the sense of ritual in actual educational activities. Based on this, the role, importance, design principles and methods of the ritual sense of educational game software are basically the same as actual educational activities. However, the ritual sense design of educational game software needs to closely integrate educational content, user characteristics, software operating platform, and software design advantages.

Principles of Design

The ritual sense design of educational game software must match the educational content. This is a relatively easy principle to understand. There are many kinds of educational content, such as mathematics, language, natural knowledge, social sciences, and painting, etc. Correspondingly, all aspects such as the scene, atmosphere and form of ritual sense design need to be coordinated with the teaching content to avoid abrupt feeling, especially to avoid conflicts and contradictions.

The ritual sense design of educational game software must match the user's background. Educational game software is usually targeted at specific user groups. Specific groups have specific characteristics in terms of age, gender, identity, educational background, hobbies, and usage needs. Therefore, the ritual sense design of educational game software needs to match the characteristics and psychological expectations of users, making it easier and more convenient for users to been deeply integrated into the designed scene, which stimulates the user's interest, identification and participation.

The ritual sense design of educational game software should match the timing of ritual setting. In order to achieve the purpose of motivating users to learn, the ritual sense design is usually combined with key moments & scene in the use of educational games, such as: points increasing, getting promotion, obtaining prizes, honors, badges, certificates, trophies, showing transcripts, rankings, etc. For different occasions, the display style and duration of the ceremonial design are different. While achieving the desired ritual sense effect, you should avoid affecting the overall coherence of the software.

The ceremonial design of educational game software must match the achievements and prize levels. The ritual sense design should correspond to the award level and the ritual form to avoid problems, such as small prize using big ceremony, grand prize using small ceremony, and different awards using the similar ritual.

The ceremonial design of educational game software needs to match the award category. According to the requirements of educational game software design, the award categories can be divided into: spiritual encouragement categories, such as certificates of merit, medals, and trophies; virtual or real material reward categories, such as game points, game coins, and items. For different types of rewards, the style or atmosphere of the ritual sense design can be solemn, lively, festive, grand or simple accordingly.

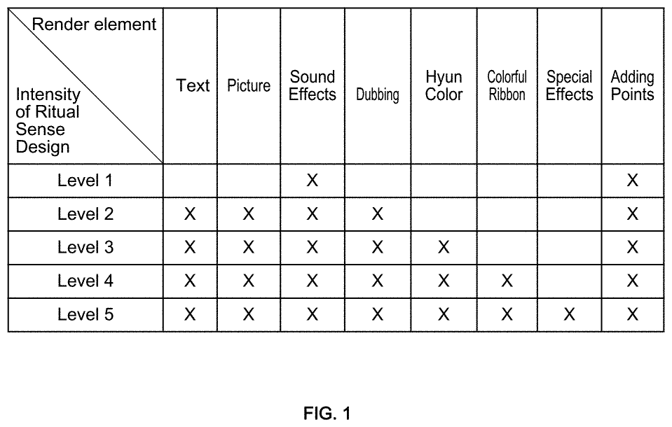

The ritual sense design of educational game software should make full use of text, pictures, animations, videos, sound effects, dubbing, colorful and other elements. The design of educational game software ritual sense needs to coordinate and mobilize the user's emotions from three aspects: visual, auditory, and tactile sense, increases user's interest, inspires a sense of identification with educational content, a sense of accomplishment and mission for in-depth learning. The sound and visual elements should be positive, and exquisitely produced with characteristics and features that are compatible with educational content and sense of ceremony. The use of text, pictures, videos, sound effects, dubbing, colorful and other elements is related to the intensity or level that the ritual sense design wants to achieve. As shown in FIG. 1, the higher the intensity or level of ritual sense design, the richer the use of text, pictures, videos, sound effects, dubbing, Hyun color, colorful ribbon, special effects, adding points, etc.

Application Scenario

The ritual design of educational game software can be applied to the following scenarios in the software, including: Adding Points for Correct Answer scenario, Getting Medals for Correct Answer scenario, Receiving Prizes scenario, Promotion scenario, Honor Presentation scenario, Role Model Presentation scenario, Study Certificate Presentation scenario, Graduation Certificate Presentation scenario, Leader-Board Presentation scenario, Transcript Presentation scenario, Study Badge Presentation scenario, Adding Buddy scenario, Receiving Gift scenario, Raffle scenario, and Adding Points for Sharing App scenario. The functions of these scenarios are as following:
Adding Points for Correct Answer scenario usually appear in the course modules of educational game software. When a user answers a question correctly, the software prompts the user that bonus points are rewarded;
Getting Medals for Correct Answer scenario usually appear in the course module of educational game software. When the user answers the set number of questions correctly, the software prompts the user that a medal is rewarded;
Receiving Prizes scenario is used to show the user the prizes obtained, and present congratulations to the user for obtaining new prizes. When the user passes a certain number of game levels or gets a set number of points, the software prompts the user that a prize is rewarded. After the user performs the corresponding operation, the user can confirm the prize;
Promotion scenario is used to show the user the obtained game level, and presents congratulations to the user for the ‘growth’ of game level. When a user passes a certain number of game levels, the software prompts the user that a new game level is obtained. After the user performs the corresponding operation, the user can confirm the obtained level;
The Honor Presentation scenario is used to show users the honor they have received, and congratulate the user for the new honor. When a user passes a certain number of game levels, the software prompts the user that a new honor is rewarded. After performing the corresponding operation, the user can confirm the obtained honor;
Role Model Presentation scenario is used to show the study role model obtained by the user, and present congratulations to the user for obtaining the new role model. The role model in educational game software are related to user's game level. The higher the user's game level, the higher the ‘level’ of the role model. When a user passes a certain number of game levels, the software prompts the user that a new role model is rewarded. After the user performs the corresponding operation, he can confirm the obtained role model;
Study Certificate Presentation scenario is used to show the obtained study certificate by the user, and present congratulations to the user for obtaining a new study certificate. When the user passes a certain number of game levels, the software prompts the user that a new study certificate is rewarded. And the user can confirm the obtained study certificate after performing the corresponding operation;
Graduation Certificate Presentation scenario is used to show the obtained diploma by the user, present congratulations to the user for obtaining diploma. The graduation certificate is used to recognize the successful completion of the learning content included in the educational game software. When a user successfully completes the learning content included in the educational game software, that is, all game levels, the software prompts the user that a graduation certificate is rewarded. After the user performs the corresponding operation, the user can confirm the obtained graduation certificate;
Leader-Boards Presentation scenario is used to show users the game performance rankings of themselves and others in the set user group, and congratulate users for achieving good rankings, or encourage users to achieve better rankings.
Transcript Presentation scenario is used to show the specific situation of the user passing each level, such as the correctness of the answer, the time spent passing the level, etc. Through this scenario, users can browse previous transcripts.
Study Badge Presentation scenario is used to show the obtained badges by the user and congratulate the user for obtaining a new badge. When the user passes a certain number of game levels, the software prompts the user that a new badge is rewarded. After performing the corresponding operation, the user can confirm the badge obtained;
Add Buddy scenario is used to add and browse buddies who use the same educational game software. Having game partners is helpful to improve the user's learning motivation and maintain interest in using the software;
Receiving gift scenario is used to receive and display gifts from relatives and friends. These gifts are set by software, and are helpful to motivate users to learn;
Adding Points for Sharing App scenario is used to encourage users to share the educational game software with friends and family. After the user performs the sharing operation, the software will reward the user with a set amount of game points.
Raffling scenario is used to let users to obtain additional bonus points or prizes through the way of raffling.

Methods of Ritual Sense Design

The ritual sense design of educational game software can be applied to the design of main interface, course modules, and achievement celebration scene, as described below.

Ritual Sense Design Methods of Main Interface

The main interface of educational game software is like the main activity place for students, the classroom. It is the main interaction platform for users to perform all operations of the software, so its design must be integrated the ceremonial design. The specific methods are as following:
Associating the background theme picture, music and other elements of the main interface with the level which users have achieved. In this way, users can communicate spiritually with educational game software, build and continuously deepen their feelings of goodwill, dignity, accomplishment and trust;
Each time the software is started or exited (similar to a student entering or leaving a classroom), a reminder message is displayed on the main interface, or before the main interface is displayed, or after the main interface is exited, to show welcome to user, or prompt information of past achievement, or encourage user to keep use of software. Information can be displayed in the form of text, pictures, animation, sound, music, etc. In this way, users can have a feeling of being concerned. It is helpful to build and continuously deepen the good feeling and intimacy between users and software.

Ritual Sense Design Methods of Course Module

The ritual sense design in the course module is usually applied at Adding Points for Correct Answer scenario, Getting Medals for Correct Answer scenario, where after the user has completed several questions. The display form can be text, pictures, animations, sounds, music, etc. The display content can be words of encouragement, obtaining awards, certificates, honors and other information.

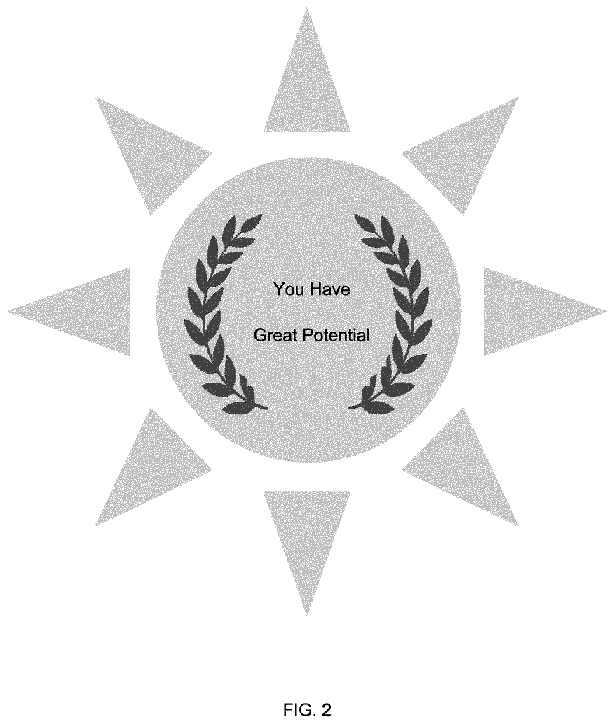

The ritual sense design in the course module is as important as the ritual sense design of the main interface, but the methods are different. The course needs to be coherent, but the ceremonial design needs to intentionally set some ‘pauses’. Therefore, the ceremonial design in the course module should take into account both the continuity requirements and the ritual sense design purpose, so as to be as short, smart, lively, novel as possible, without giving users a redundant, boring feeling. FIG. 2 is an illustration of the sense of ritual sense design of course module.

Ritual Sense Design Methods of Achievement Celebration Scene

Achievement celebration rituals have the same role in cultivating a sense of ritual as in actual educational activities. Therefore, the ritual sense design around the achievement celebration ceremonies is the focus of the ceremonial design of educational game software to stimulates the sense of honor and mission of educational game software users. Since the achievement celebration ceremony function of educational game software is specially used to recognize and encourage users' learning achievements, compared with the ceremonial sense design in the course module, the display duration of rituals is relatively long, and the display content and display form can be more abundant.

The achievement celebration ceremony should create the required celebration atmosphere, constantly mobilize the emotions of participants in the ceremony, including users, parents, friends, teachers, etc. With the improvement of the software and hardware capabilities of the educational game software operation platform, there are more and more multimedia display methods and Information interaction function which can be used in the design of celebration ceremony to make the desired effects, such as ribbons or stars falling like a waterfall Scenes, colorful fireworks, colorful eggs, colorful balls exploding, beautiful multimedia certificates, greeting cards, warm applause.

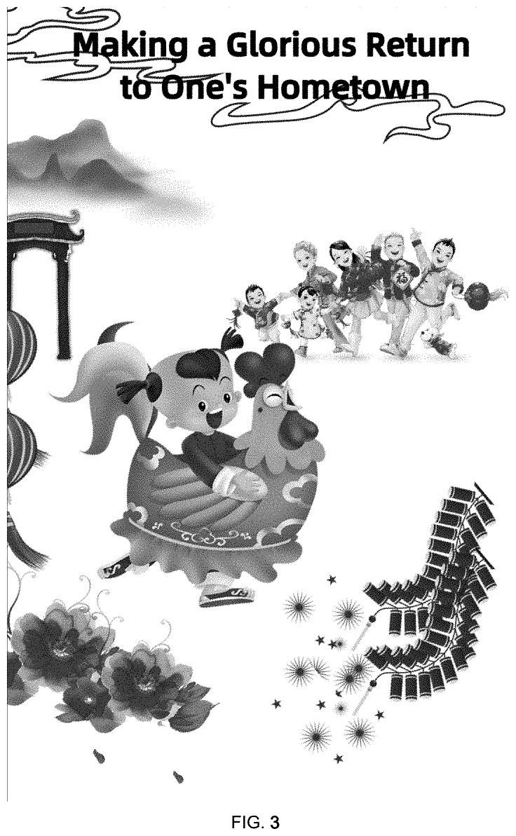

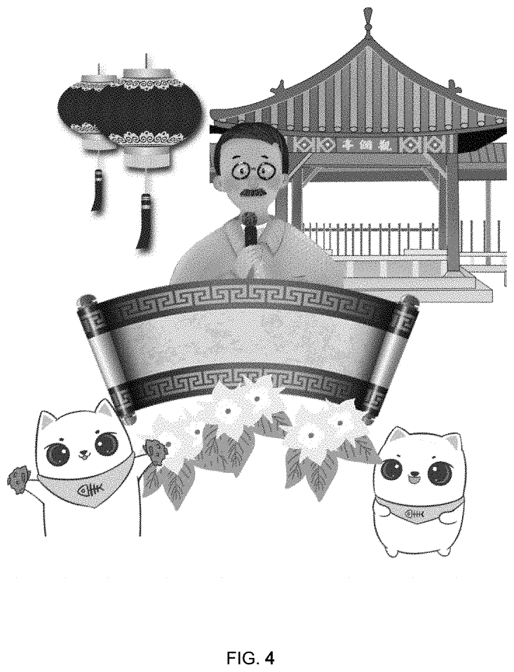

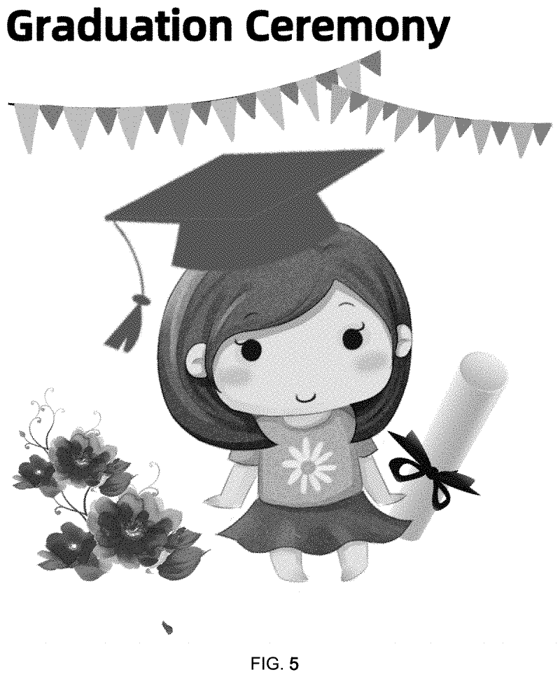

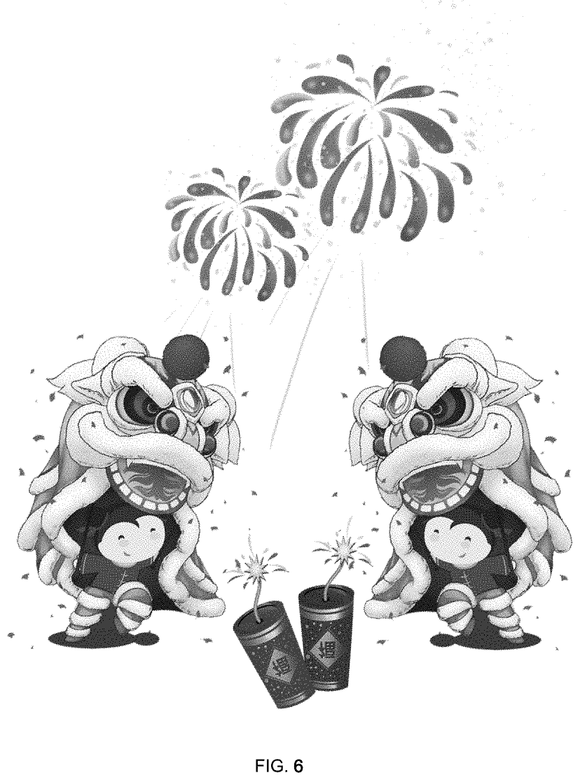

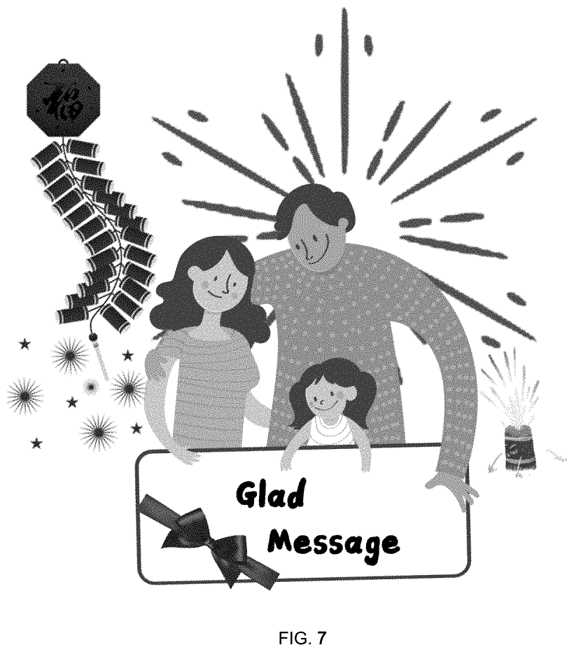

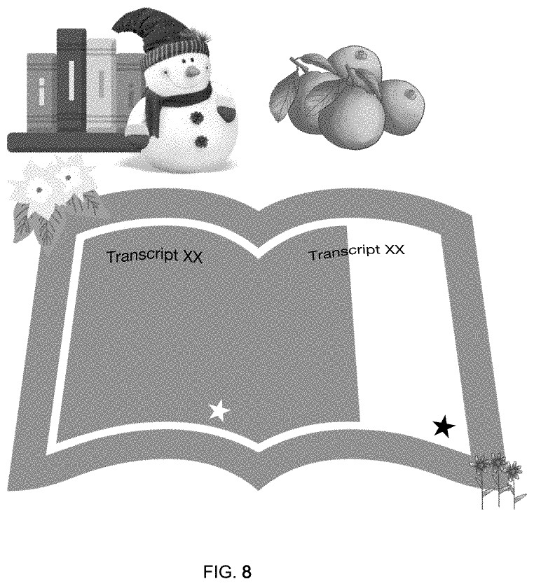

This patent contains the following ritual sense design methods of achievement celebrations, including:
Opening treasure chest mode. This mode is mainly used in the Receiving Prizes scenario. Although opening treasure chests is common in some other game software, there are some differences in the treasure chest modes described in this patent. Based on the design idea of strengthening the sense of ceremony, the opening treasure chest mode described in this patent uses multimedia means to focus on enhancing the rendering of the atmosphere before and after the treasure chest is opened, so as to increase the user's expectation for the treasure chest opening;
Making A Glorious Return to One's Hometown mode. This mode is mainly used in the Honor Presentation scenario. With reference to the celebration for the Number One Scholar, a title conferred on the one who came first in the highest imperial examination in ancient China, animations, music and other means are used to render the lively scenes of greeting the Number One Scholar who is dressing up in splendid attire, majestically riding a horse, with people lining the streets to welcome, drums being played and gongs being played. FIG. 3 is a legend of Making a Glorious Return to One's Hometown mode;
Succeeding in Imperial Examination mode. This mode is mainly used in Promotion scenario. With reference to the form of the announcement of the winner in the Golden Palace in ancient China, a grand atmosphere was rendered. FIG. 4 is a legend of Succeeding in Imperial Examination mode;
Graduation Ceremony mode. This mode can be applied in the Graduation Certificate Presentation scenario. Referring to the form of the school's graduation ceremony, the solemn and warm atmosphere is built by means of a mock announcement of successful graduation, warm applause, etc. FIG. 5 is an illustration of a Graduation Ceremony mode;
Universal Celebrations mode. This mode can be applied in the Role Model Presentation scenario. Referring to the form of festival celebrations, a warm celebration atmosphere is rendered. FIG. 6 is a legend of Universal Celebrations mode;
Family Celebration mode. This mode can be applied in the Study Certificate Presentation scenario. Referring to the family celebrations, an atmosphere is rendered by displaying firecrackers and simulating banquets for family and friends. FIG. 7 is an illustration of Family Celebration mode;
Personal Celebration mode. This mode can be used in the Leader-Board Presentation scenario, Transcript Presentation scenario, Study Badge Presentation scenario. In this mode, the photo album form is used to show transcripts that users have obtained; users can choose cartoon characters related to educational content, or upload personal pictures to personalize themselves on the leader-board; and badges can be shown as a picture or animation which reflects the concept of constant climbing up. FIG. 8 is an illustration of Personal Celebration mode;
Teacher Rewarding Sticker mode. This mode can be used in the Adding Points for Correct Answer scenario, Getting Medals for Correct Answer scenario, Promotion scenario, Honor Presentation scenario, Study Certificate Presentation scenario, Graduation Certificate Presentation scenario, Leader-Board Presentation scenario, Transcript Presentation scenario, etc. This mode encourages users by simulating the way teachers praise students with stickers.
Happy Surprise mode can be used in the Raffling scenario, and Adding Points for Sharing App scenario. After a user performs the corresponding operation and gets reward, a happy atmosphere is presented with music, animation, etc.

1. A set of methods that can be used in the specific scenarios design of educational game software running on mobile devices to improve the user's motivation for learning. The specific scenarios include Adding Points for Correct Answer scenario, Getting Medals for Correct Answer scenario, Receiving Prizes scenario, Promotion scenario, Honor Presentation scenario, Role Model Presentation scenario, Study Certificate Presentation scenario, Graduation Certificate Presentation scenario, Leader-Board Presentation scenario, Transcript Presentation scenario, Study Badge Presentation scenario, Adding Buddy scenario, Receiving Gift scenario, Raffle scenario, and Adding Points for Sharing App scenario.

2. The methods of claim 1, wherein the set of methods for design of ritual sense of educational game software, comprising: ritual sense design methods of the main interface; ritual sense design methods of course module; ritual sense design methods for achievement celebration scene.

3. The methods of claim 2, wherein the ritual design sense methods of the main interface, its functions is as following:
associating the background theme picture, music and other elements of the main interface with the level which users have achieved;
each time the software is started or exited, a reminder message is displayed on the main interface, or before the main interface is displayed, or after the main interface is exited;

4. The methods of claim 2, wherein the ritual sense design methods of course module is to display words of encouragement, obtaining awards, certificates, honors and other information when a user completes several questions.

5. The methods of claim 2, wherein the ritual sense design methods of achievement celebration scene is to make full use of various multimedia display methods and software interconnection functions to create the celebration atmosphere required for the celebration ceremony. The methods can be divided into nine modes, including: Opening Treasure Chest mode; Making A Glorious Return to One's Hometown mode; Succeeding in Imperial Examination mode; Graduation Ceremony mode; Universal Celebrations mode; Family Celebration mode; Personal Celebration mode; Teacher Rewarding Sticker mode, Happy Surprise mode. The functions of the eight modes are as following:
The Opening Treasure Chest mode is mainly used in the Receiving Prizes scenario. This mode applies multimedia means to enhance the rendering of the atmosphere before and after the treasure chest is opened;
The Making A Glorious Return to One's Hometown mode is mainly used in the Honor Presentation scenario. With reference to the celebration for the Number One Scholar, animations, music and other means are used to render the lively scenes of greeting the Number One Scholar with people lining the streets to welcome, drums being played and gongs being played;
The Succeeding in Imperial Examination mode is mainly used in Promotion scenarios. With reference to the form of the announcement of the winner in the Golden Palace in ancient China, a grand atmosphere was rendered;
The Graduation Ceremony mode can be applied in the Graduation Certificate Presentation scenario. Referring to the form of the school's graduation ceremony, the solemn and warm atmosphere is built by means of a mock announcement of successful graduation, warm applause;
The Universal Celebrations mode can be applied in the Role Model Presentation scenario. Referring to the form of festival celebrations, a warm celebration atmosphere is rendered;
The Family Celebration mode can be applied in the Study Certificate Presentation scenario. Referring to the family celebrations, an atmosphere is rendered by displaying firecrackers and simulating banquets for family and friends;
Personal Celebration mode can be used in the Leader-Board Presentation scenario, Transcript Presentation scenario, Study Badge Presentation scenario. In this mode, the photo album form is used to show transcripts that users have obtained; users can choose cartoon characters related to educational content, or upload personal pictures to personalize themselves on the leader-board; and badges can be shown as a picture or animation which reflects the concept of constant climbing up;
Teacher Rewarding Sticker mode. This mode can be used in the Adding Points for Correct Answer scenario, Getting Medals for Correct Answer scenario, Promotion scenario, Honor Presentation scenario, Study Certificate Presentation scenario, Graduation Certificate Presentation scenario, Leader-Board Presentation scenario, Transcript Presentation scenario, etc. This mode encourages users by simulating the way teachers praise students with stickers;
Happy Surprise mode can be used in the Raffling scenario, and Adding Points for Sharing App scenario. After a user performs the corresponding operation and gets reward, a happy atmosphere is presented with music, animation, etc.
